(19) United States
(12) Patent Application Publication
(10) Pub. No.: US 2026/0357514 A1
(43) Pub. Date: Nov. 12, 2026

(54) A process for the preparation of micro- and/or nanocellulose that is surface functionalized with lactic acid ester

(71) Applicant: XyloTech Innovations AB, Sundsvall (SE)

(72) Inventors: Armando Córdova, Stockholm (SE); Abdolrahim Rafi, Sundsvall (SE)

(73) Assignee: XyloTech Innovations AB, Sundsvall (SE)

(21) Appl. No.: 19/129,796

(22) PCT Filed: Nov. 13, 2023
(86) PCT No.: PCT/EP2023/081668

§ 371 Date: May 14, 2025

Related U.S. Application Data
(60) Provisional application No. 63/383,535, filed on Nov. 14, 2022.

(30) Foreign Application Priority Data
Nov. 14, 2022 (US) 63/383535

(51) Int. Cl. D21C 9/00; D21H 11/18; D21H 11/20

(52) U.S. Cl. CPC D21C 9/005; D21C 9/007; D21H 11/18; D21H 11/20

(57) ABSTRACT

The present invention relates to a process for the preparation of micro- and/or nanocellulose that is surface functionalized with lactic acid ester, comprising the step of a) mixing wood-derived pulp with 80 to 99 wt % lactic acid at a temperature from 90 to 120 °C for 5 to 36 hours under stirring, wherein wt % are weight percentages of the total weight of the solution or of the final material.

### FIELD OF THE INVENTION

The present invention relates to a one step process for the preparation of micro- and/or nanocellulose that is surface functionalized with lactic acid ester.

### BACKGROUND OF THE INVENTION AND PRIOR ART

It is of utmost importance to expand the use and application of materials derived from renewable natural resources, which can decrease the dependence on fossil-based materials and plastics, for addressing global environmental challenges on land and in the oceans. In this context, cellulose is the most abundant biomaterial on earth, which is synthesized by photosynthesis at a rate of between 1011 and 1012 tons/year. This renewable polysaccharide can be converted into micro- and/or nanocellulose, which can be isolated as cellulose micro- and/or nanofibers (CNFs) and/or cellulose micro- and/or nanocrystals (CNCs). This has sparked an intense research interest in both academia and industry.

CNFs (5-60 nm width, 0.1-2 μm length) have important properties, such as biodegradability, biocompatibility, high mechanical strength, high toughness, and low density. Thus, CNFs have great potential for usage in several applications in various fields, such as nanocomposites (as a reinforcement agent), packaging, printed electronics, medicine, and paper. CNFs have been fabricated from renewable resources (e.g. agricultural residues, wood, grass) by means of different methodologies. Mechanical agitation is a common method for CNF fabrication. However, CNF production using mechanical fibrillation (e.g. from wood derived pulp fibers) is extremely energy intensive and requires high energy consumption (generally >30,000 kWht⁻¹, 700-1400 MJ kg⁻¹). Chemical treatment could decrease energy usage for CNF production. For example, the required energy for CNF fabrication was extensively reduced to <7 MJ kg-1 as first shown by Isogai and co-workers by using sequential oxidation (2,2,6,6-tetramethylpiperidine-1-oxyl (TEMPO), sodium hypochlorite (NaClO)) (Isogai, A., Saito, T. & Fukuzumi, H. TEMPO-oxidized cellulose nanofibers. Nanoscale 3, 71-85 (2011). However, issues, such as using an active radical initiator and a non-selective chlorine-based oxidant are drawbacks for this approach especially in large scale fabrication. CNF production by combined enzymatic hydrolysis/homogenization treatment also requiring a low energy consumption. Among the vide supra described CNF production methods, enzymatic hydrolysis/homogenization and mechanical agitation have the least environmental impact. However, enzymatic hydrolysis is usually time-consuming and other factors such as the costs and stability, which leads to biocide addition, can be disadvantageous for the users.

Studies revealed the successful fabrication of functionalized CNCs using oxalic acid or citric acid as the reaction media with or without a catalytic amount of HCl. In addition, formic acid esterified CNCs can be fabricated in neat formic acid using HCl as a co-catalyst. Other organic acids such as citric acid, benzoic acid, 2-phenyl acetic acid, lactic acid and acetic acid have also been used as the neat reaction media (no solvent) for fabrication of organic acid-grafted CNCs generally using a strong mineral acid as catalyst (Fischer esterification). Functionalization of celluloses is beneficial since it can improve the thermal stability and dispersion of the nanocellulose in polymeric matrixes, open for further functionalization as well as novel applications and click chemistry.

In 1780, lactic acid (LA) was isolated from sour milk for the first time by Scheele and has a big research interest both in industry and academia. Lactic acid is an organic acid that is biodegradable and relatively inexpensive and is produced on a large scale. Lactic acid is environmentally friendly since it would have less environmental impact during its disposal, and it could be produced via microbial fermentation of renewable resources. In addition to the above advantages, LA-esterification of nanocelluloses could make them more applicable and compatible with biodegradable polymers. As described vide supra, one approach to reach these nanocellulose products would be the concurrent LA esterification and nanocellulose fabrication using a Brønstedt acid catalyst, such as HCl. In this context, it was recently reported that lactic acid functionalized CNCs can be produced from cotton liner using a mixture of lactic acid and concentrated HCl at 150 °C. Unlike CNC, CNF may exhibit both amorphous and crystalline parts and presents a web-like structure. CNFs generally have a higher strength and modulus than CNCs due to CNFs' larger aspect ratio and fiber entanglement.

Moreover, post modification of CNFs, meaning cellulose having a maximum diameter of 1 μm or less and includes cellulose microfiber or microfibrilated cellulose (MFC) and CNF, with lactic acid ester groups was recently done using metal-based compounds as catalysts. Strong acids, such as HCl are hard to handle, corrosive and generate chlorine ions. Use of HCl becomes even more challenging and costly during scale-up. Based on our previous research, the inventors became intrigued whether a Brønstedt acid co-catalyst can be avoided for preparing LA-modified nanocelluloses. In other words, can LA-modified nanocelluloses be fabricated and esterified using a mild an organocatalytic and metal-free technology. Notably, it is believed that lactic acid itself is not strong enough to convert cellulose fibers into functional micro- and/or nanocelluloses, especially when using cellulose derived from wood-derived cellulose.

### SUMMARY OF THE INVENTION

It is an object of the present invention to at least partly overcome the above-mentioned problems, and to provide an improved process for the preparation of micro- and/or nanocellulose that is surface functionalized with lactic acid ester.

This object is achieved by a process for the preparation of micro- and/or nanocellulose that is surface functionalized with lactic acid ester, comprising the step of
a) mixing wood-derived pulp with 80 to 99 wt % lactic acid at a temperature from 90 to 120 °C for 5 to 36 hours under stirring,
wherein wt % are weight percentages of the total weight of the solution or of the final material.

In some aspects, cellulose has a diameter of 1 m or less. In some aspects, cellulose is microfibrilated cellulose (MFC) and/or CNF. In some aspects, cellulose is CNF.

In some aspects, the use of a solvent is disclaimed.

In some aspects, the use of a co-catalyst is disclaimed.

In some aspects, the use of a metal catalyst is disclaimed.

In some aspects, the use of further acids, like HCl, is disclaimed.

The disclosed sustainable one-step selective esterification and micro- and/or nanocellulose process of the invention was advantageous, straightforward, and eco-friendly. With cellulose being the most abundant biomaterial. Even lactic acid is an organic acid that is biodegradable and relatively inexpensive and is produced on a large scale. Therefore, the process can be used at a large scale at relatively low cost for starting material. No toxic and harsh reagents or conditions need to be used in the process of the invention. This reduces costs for expensive equipment or enzymes and cleaning of waste. In the process of the invention, the number of process steps are reduced. The new process allows for large scale production of surface functionalized micro- and/or nanocellulose in an environmentally and economically beneficial manner. The obtained CNFs are biodegradable, biocompatible, have high mechanical strength, high toughness, and low density. The obtained CNFs can be used as micro- and/or nanocomposites (as a reinforcement agent), packaging, printed electronics, medicine, and paper.

In some aspects, the wood-derived pulp is one or more short-rotation energy crops selected from softwoods and hardwoods.

In some aspects, the wood-derived pulp is one or more softwoods selected from the group comprising pine, spruce, birch and cedar. In some aspects, the wood-derived pulp is pine or spruce.

The process allows the use of any type of wood-derived pulp. Hence, any type of waste pulp from, for example, the paper industry can be used. This improves the environmental benefit of the process.

In some aspects, the wood-derived pulp is sulphite dissolved wood-derived pulp. Although, it seems that any type of dissolved wood-derived pulp may be used in the process, sulphite dissolved wood-derived pulp is most abundantly available from paper industry. The fact that sulphite dissolved wood-derived pulp can be used improves the environmental benefit of the process.

In some aspects, lactic acid is used at a concentration of 85 to 95 wt %. The wt % for lactic acid results in a (selective) production of surface functionalized micro- and/or nanocellulose in an environmentally and economically beneficial manner.

In some aspects, the temperature is from 100 to 110 °C. This relative low temperature reduces costs for the process, especially at large scale.

In some aspects, the process is performed for 10 to 30, or 20 to 37 hours. The mild conditions of the defined time periods combined with the temperature intervals mentioned above result in a (selective) production of surface functionalized micro- and/or nanocellulose in an environmentally and economically beneficial manner.

In some aspects, lactic acid is D,L-Lactic acid or L-Lactic acid.

In some aspects, the esterification in step a) is reversible.

In some aspects, stirring is homogenization.

In some aspects, the process comprises an additional step b) removing the obtained ester by alkaline hydrolysis.

In some aspects, the process comprising the steps of
a) mixing wood-derived pulp with 80 to 99 wt % lactic acid at a temperature from 90 to 120 °C for 5 to 36 hours under stirring,
a-2) cooling the mixture,
a-3) separating solid and supernatant, which supernatant can optionally be recycled,
a-4) washing the solid,
a-5) drying the solid,
optionally, b) removing the obtained ester by alkaline hydrolysis.

In some aspects, lactic acid is recycled. In some aspects, lactic acid is recycled at least seven times. The organic waste from the process is reduced by reuse of lactic acid. This improves the eco-friendliness of the process and reduces costs, especially at large scale production.

In some aspects, the obtained micro- and/or nanocellulose has a Degree of Substitution (DS) between 0.15 and 0.25, or 0.20 and 0.22. This DS shows that the substitution on the surface of the cellulose using the process of the invention is selective or even regioselective.

### BRIEF DESCRIPTION OF THE DRAWINGS

The invention will now be explained more closely by the description of different aspects of the invention and with reference to the appended figures.

FIG. 1 shows a schematic process for fabrication of lactic acid functionalized CNFs.

FIG. 2 shows FT-IR spectra of (a) cellulose starting material sulphite pulp (spectrum a), (b) LA functionalized CNFs (in the presence of HCl 0.1 M), (c) LA functionalized CNFs (in the presence of HCl 0.05 M), and (d) LA functionalized CNFs (No added HCl).

FIG. 3 shows a solid-state CP/MAS ¹³C NMR spectra; red spectrum for sulphite pulp as starting material, and blue spectrum for LA functionalized CNF (using lactic acid in the presence of HCl 0.1 M).

FIG. 4 shows HAADF-STEM images of LA functionalized CNFs; (a1, a2) fabricated with lactic acid and HCl 0.1 M, and (b1, b2) fabricated with lactic acid (without adding HCl).

FIG. 5 shows (a) TGA curves of sulphite pulp, LA functionalized CNFs fabricated in the presence of HCl 0.1 M, with no added HCl, and no added HCL before homogenization. (b) DTG curves of the related samples.

### DETAILED DESCRIPTION OF VARIOUS EMBODIMENTS OF THE INVENTION

### Definitions

As used herein “wood-derived cellulose” means pulp made of hardwood or softwood.

As used herein “short-rotation energy crops” means fast growing softwoods, such as pine, spruce, birch and cedar or hardwoods, such as aspen, cotton woods, poplar, willow, and eucalyptus.

wt % as used herein are weight percentages of the total weight of the solution or of the final material.

v % as used herein are volume percentages of the total volume of the solution or of the final material.

As used herein “nanocellulose” means cellulose having a maximum diameter of 1 μm or less and includes cellulose microfiber or microfibrillated cellulose (MFC) and CNF. “Diameter” means the maximum length of a cellulose particle. Even though, the expressions nanocellulose and CNF are used throughout the description and in the drawings, a skilled person would understand that the obtained product also includes larger particles of cellulose, such as esterified cellulose particles in millimeter to nanometer size.

The investigation began using bleached sulphite pulp as the substrate and lactic acid (pKa of 3.86) as the neat reaction media (i.e. no solvent). In addition to discovering an organocatalytic micro- and/or nanocellulose fiber fabrication route with concurrent esterification, there was a wish to develop a green process, where the sustainable and biodegradable lactic acid could be successfully reused again (FIG. 1).

The condition screening revealed to our delight that CNF can be produced in high yields using just lactic acid as the media (Table 1). For example, the yields of CNF when usingjust D,L-lactic acid (LA) or L-Lactic acid (LLA) were 92 and 91 wt %, respectively (entries 1 and 2). The results revealed that adding a co-catalytic amount of HCl significantly decreased the yields. In these cases, the yields using 0.05 and 0.1 M HCl as the co-catalyst were 73 and 65 wt %, respectively (entries 3 and 4).

The CNFs degree of substitution (D.S.) of lactic acid was determined according to literature using alkaline titration. In all the entries shown in Table 1, the D.S. was between 0.20 and 0.22. This degree of substitution corresponds to a degree of esterification on every fifth glucose unit and confirms a selective surface functionalization.

In addition, the esterification is reversible, and the ester groups can be removed using alkaline conditions. This could be desirable for certain types of applications, such as assembly of native elementary CNFs. The results presented in Table 1 also demonstrate that LA-mediated concurrent hydrolysis and esterification, which is autocatalytic, of sulphite pulp is enough for generating CNFs.

TABLE 1
Fabrication of CNFs.

| Entry | Reaction media^{a} | Acid conc.^{b} | Yields wt %^{c} | d.s.^{d} |
|---|---|---|---|---|
| 1 | LA | — | 92 | 0.21 |
| 2 | LLA | — | 91 | 0.21 |
| 3 | LA + HCl | 0.05M | 73 | 0.20 |
| 4 | LLA + HCl | 0.1M | 65 | 0.22 |

^{a}Temperature: 105 °C, Reaction time: 24 h.
^{b}Total Concentration of HCl in the reaction medium.
^{c}Isolated yields of pure CNF (wt %).
^{d}Degree of substitution determined according to Lu, X., Luo, Z., Fu, X. & Xiao, Z. Two-step method of enzymatic synthesis of starch laurate in ionic liquids. J. Agric. Food Chem. 61, 9882-9891 (2013).

Recycling of the reaction media and avoidance of waste generation are important factors in developing green chemistry and industrialized scale-up. Thus, the recyclability of lactic acid-mediated micro- and/or nanocellulose production process was investigated (Table 2).

TABLE 2
Recycling and reusing of the LA media in the CNF fabrication.^{a}

| Cycles | Yields (wt %) | Yields (wt %)b |
|---|---|---|
| 1st | 92 | 73 |
| 2nd | 91 | 77 |
| 3rd | 91 | 82 |
| 4th | 92 | 85 |
| 5th | 91 | 83 |
| 6th | 92 | 84 |
| 7th | 92 | 85 |

^{a}Bleached sulphite pulp (25 g) was inserted into a round-bottom flask and lactic acid (90 wt %, 1 L) was added. After stirring the reaction mixture with a mechanical stirrer (1400 rpm) at 105 °C for 24 h, it was cooled down to room temperature. The reaction mixture was next transferred to a tube and centrifuged (12,000 rpm for 14 min). The CNFs were isolated, and the supernatant was collected and reused as the reaction media in the next reaction cycle.
bHCl (37 wt %, 4.2 mL, total concentration of 0.05M) was also added. N.d., not determined.

It was found that the catalytic lactic acid media could be recycled for multiple process cycles giving the corresponding lactic acid esterified CNF in high yields. In comparison, when adding a co-catalytic amount of HCl (0.05 M) the CNF is produced in lower yields.

In addition, the yield of the lactic acid modified CNF increased as the reaction cycles increases. This is due to a decrease in acidity of the reaction media as can be noticed after the third cycle, when starting with a co-catalytic amount of HCl. In addition, the recycling is readily performed at a 25-g scale maintaining a high yield of the generated micro- and/or nanocellulose.

### FT-IR Spectra

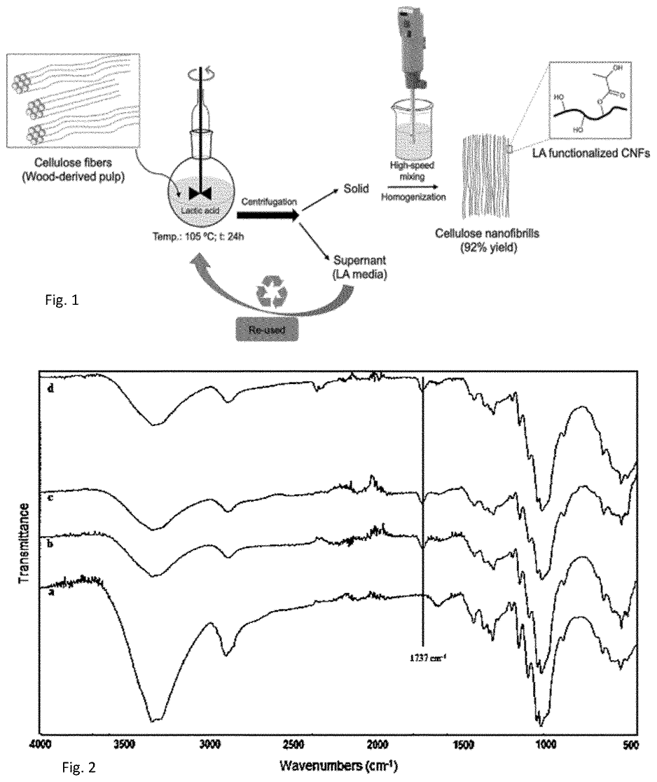

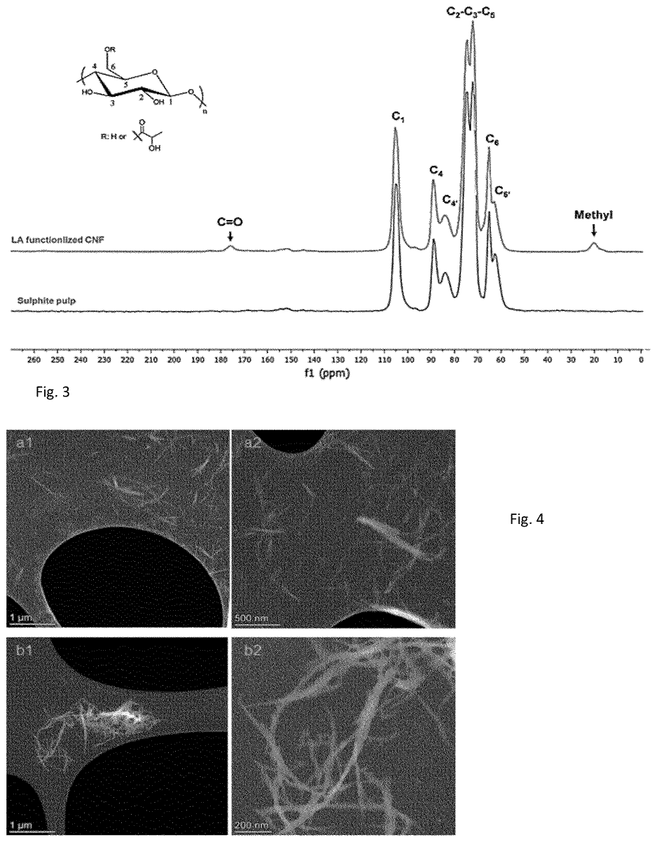

The FT-IR spectra of bleach sulphite pulp (cellulose) and LA functionalized CNFs are presented in FIG. 2. The wide absorption peaks in all spectra around 3335 cm⁻¹ and 2892 cm⁻¹ are attributed to the O—H and C—H stretching vibrations, respectively. The absorption bands around 1638 cm⁻¹ correspond to the O—H bending vibrations of the hydroxyl groups of absorbed water. The absorption bands around 1161 cm⁻¹ and 1103 cm⁻¹ are attributed to the stretching vibrations of C—C and C—O, respectively. The absorption peaks around 1027 cm⁻¹ comes from the vibration of C—O—C in the pyranose. It is noteworthy that a new peak appears around 1737 cm⁻¹ in the CNFs spectra, which corresponds to an ester bond. Thus, the presence of this peak confirms that lactic acid esterification of the hydroxyl groups of the CNFs had occurred. The same peak was also observed in the FT-IR spectra of the CNFs produced by using recycled LA media, which shows that successful esterification also occurred in these cases.

### Solid State CP/MAS ¹³C NMR

FIG. 3 shows the solid-state CP/MAS ¹³C NMR spectra of sulphite pulp (starting material) and LA functionalized CNFs (using lactic acid and HCl 0.1 M). The sulphite pulp spectrum depicts the characteristic carbon resonances of cellulose at 105 ppm, 89 ppm, and 66 ppm for C1, C4, and C6, respectively. C4′ and C6′ are assigned to amorphous parts that come at 84 ppm and 63 ppm, whereas the C4 and C6 correspond to the ordered cellulose structure. The cluster at 72-75 ppm belongs to C2-C3-C5 in cellulose. In comparison with sulphite pulp spectrum, LA functionalized CNF has two new signals at 20 ppm that belongs to —CH₃ of LA, and 176 ppm is assigned to carbonyl group (CO) confirming the happening of the esterification reaction between LA and hydroxyl groups in CNFs. No ester peaks corresponding to oligomeric lactide or poly(lactide were observed. Moreover, the degree of substitution of the lactic acid esterified CNF is low (see Table 1) and according to the literature by Iversen the organic acid-catalyzed esterification is regioselective (Persson, P. V., Casas, J., Iversen, T. & Córdova, A. Direct organocatalytic chemoselective synthesis of a dendrimer-like star polyester. Macromolecules 39, 2819 (2006)). It is also in accordance with the proposal by Spinella et al. (Spinella, S. et al. Concurrent cellulose hydrolysis and esterification to prepare a surface-modified cellulose nanocrystal decorated with carboxylic acid moieties. ACS Sustain. Chem. Eng. 4, 1538-1550 (2016)).

Moreover, the crystallinity index was calculated from solid state CP/MAS ¹³C NMR spectra by dividing the area under C4 crystalline peak (C4 from 86.6 to 93 ppm) by the total area of C4 resonances from residual amorphous and crystalline domains (C4+C4′ from 80 to 93 ppm). The crystallinity indexes of sulphite pulp and LA functionalized CNF (using LA and HCl 0.1 M) were in the same range and calculated to be 0.52 and 0.53, respectively. Since the crystallinity index is nearly the same, the process did not afford cellulose nanocrystals. In contrast to cellulose nanocrystals (CNCs), CNFs generally lead to higher strength and modulus than CNCs due to CNFs' larger aspect ratio and fiber entanglement.

### Transmission Electron Microscopy (TEM)

FIG. 4, depicts the TEM images of LA functionalized CNFs, fabricated using lactic acid and HCl 0.1 M (a1, a2) or just lactic acid (b1, b2), respectively, in different magnifications. According to the TEM images, the fabricated LA functionalized CNFs have nano-size structures. The aspect ratio for the CNFs shown in a1,a2 and b1,b2 are 17 and 25, respectively. CNFs are assumed to have a high strength and modulus.

### Thermal Analysis

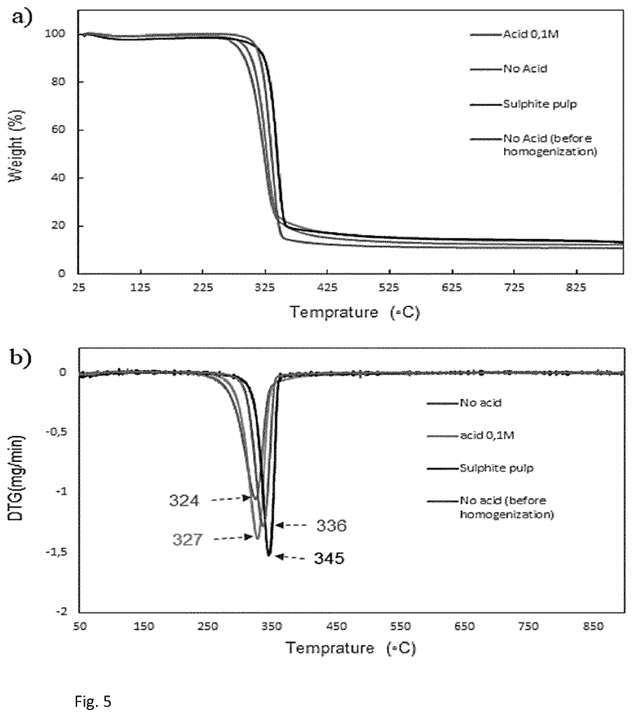

TGA and DTG curves of the cellulose sulphite pulp, LA-functionalized CNF fabricated by autocatalysis (no acid) and LA-functionalized CN fabricated by LA and HCl (0.1 M) co-catalysis are depicted in FIG. 5. Two main weight losses for each sample were observed for the TGA curves. The initial weight loss (around 80 °C) was attributed to the evaporation of water from the samples. Next, a significant weight loss owing to the decomposition and degradation of the sample was observed. No significant differences between the TGA curves related to the LA-functionalized CNF were observed. However, the thermal stability of the CNF is slightly lower than that of the starting sulphite pulp. The lower degradation temperature of the prepared CNF samples as compared to the starting material could be due to the smaller fiber dimensions of the CNF as compared to that of sulphite pulp.

### The Effect of Lactic Acid Modification

The effect of lactic acid modification was also investigated. Thus, films were prepared from the LA functionalized CNF and just CNF obtained after removal of the lactic acid groups by alkaline hydrolysis, respectively. Next, the mechanical properties of the film were investigated. It was found that the strength properties slightly increased by the lactic acid modification (Table 3). The contact angle was also investigated for the LA-CNF-derived and CNF-derived film, respectively. The contact angles were 58±1° for the LA-CNF film and 42±3° for the CNF film. Thus, lactic acid modification of the CNF slightly improved the contact angle.

TABLE 3
Mechanical data of the prepared films at 50% RH.

| | E-modulus | Strain at | Tensile |
|---|---|---|---|
| Sample | [GPa] | break [%] | strength [MPa] |
| LA-CNF | 5.7 ± 0.3 | 1.3 ± 0.3 | 42 ± 1 |
| CNF (hydrolysed LA-CNF) | 5.1 ± 0.4 | 1.3 ± 0.2 | 39 ± 2 |

The effect of adding CNF and LA modified CNF to poly(lactic acid) (PLA) was investigated. It was found that both increased the strength of the PLA. With CNF, giving the highest improvement of the strength.

Environmentally benign methods for producing micro- and/or nanocellulose fibers in large scale is very important. Moreover, selective functionalization of micro- and/or nanocellulose fibers with lactic acid ester groups gives “cellulose lactate” improve compatibility with other biodegradable polymers (e.g. poly(lactic acid), poly(ε-caprolactone)) and plastics. Herein, a scalable and selective process for the concurrent direct esterification and fabrication of CNFs from wood-derived pulp is presented in high yields using lactic acid as reaction media and as catalyst. The disclosed lactic acid-media for the micro- and/or nanocellulose fabrication process is recyclable and can be used for multiple cycles at large scale without affecting the yield or degree of substitution of the produced micro- and/or nanocellulose lactate fibers. Thus, the disclosed process full-fills important green chemistry criteria (limiting waste, high selectivity, no toxic chemicals, sustainable starting material and product, recyclable, atom economic, low energy, high yielding, one-step), is industrially relevant and an eco-friendly process for fabricating biodegradable functionalized CNF. The obtained CNF has potential industrial usage in variety of applications, such as sustainable filaments, composites, packaging, nonwoven materials, and strengthening of recycled fibers.

### Experimental Section

### Materials

Bleached sulphite dissolved softwood pulp (70% Norway spruce (Picea abeis) and 30% Scots pine (Pinus sylvestris)) was received from Domsjö Fabriker AB (Sweden). D,L-Lactic acid (90 wt %), L-Lactic acid (98 wt %) and Hydrochloric acid (37 wt %) were purchased from VWR BDH chemicals. All chemicals were used as received without further purification.

### Solid State CP/MAS ¹³C NMR

Solid state NMR spectra were recorded by means of a BrukerAvance III 500 MHz spectrometer equipped with a 4 mm HX CP MAS probe. Experiments were acquired at a magic angle spinning (MAS) rate of 10 kHz and the temperature 298 K. The cross-polarization (CP) experiments used a 90° excitation pulse of 3 us for 1H, followed by a contact time of 1.5 ms with a ¹³C spin lock frequency of 60 kHz while 1H was ramped from 45 up to 90 kHz. The 1H decoupling scheme at 83 kHz was applied during the acquisition. The relaxation delay was 2 s and Adamantane was used as an external reference with the CH₂ signal at 38.48 ppm.

The crystallinity index was determined by separating the C4 region of the spectrum into amorphous and crystalline peaks, then dividing the area under the C4 crystalline peak (86.6 to 93 ppm) by the total area of C4 resonances from residual amorphous and crystalline domains (80-93 ppm).

### Fourier Transform Infrared Spectroscopy (FT-IR)

Thermo Scientific NICOLET 6700 FT-IR (Smart orbit, Diamond 30,000-200 cm⁻¹) was used to record the FT-IR spectra.

### Transmission Electron Microscopy (TEM)

All TEM experiments were carried out on a 200 kV JEOL JEM-2100F field-emission electron microscope equipped with an ultra-high resolution pole piece A Gatan ultra high tilt tomography holder was used. Each image per tilt angle was recorded with a Gatan Ultrascan 1000 camera. The data acquisition was assisted by a commercial tomography packed, TEMography (version 2.15.07) developed by JOEL System Technology Co Ltd.

### Synthesis of LA Functionalized CNFs (no HCl Added).

To a round-bottom flask (500 mL), sulphite pulp (5 g) and lactic acid (90 wt %, 200 mL) were added. After stirring the reaction mixture with a mechanical stirrer (1400 rpm) at 105 °C for 24 h, the reaction temperature was cooled to room temperature and the reaction mixture transferred to a centrifuge vial (250 mL). Centrifugation (12,000 rpm, 14 min) was followed by separation of the supernatant, which was reused for additional reaction runs (recycling), and the solid material was collected. The collected solids were re-dispersed in distilled water and washed by centrifugation (3×200 mL H₂O). Next, the washed solid cellulose was dispensed into distilled water (200 mL) and homogenized (IKA® T25 ULTRA TURAX, 14,000 rpm) for 90 min. A sample was taken from the suspension for TEM analysis. To determine the yield of the CNF, the suspension was centrifuged (12,000 rpm, 14 min) and next the water was decanted. The CNF solids were collected and dried under rotavapor at 65 °C. The solid CNF was broken down into a powder using mortar and pestle and dried for 18 h under vacuum. The yield of the CNF was 88 wt %.

### Synthesis of LA Functionalized CNFs in the Presence of HCl, 0.05 M

To a round-bottom flask (500 mL), sulphite pulp (5 g), lactic acid (90 wt %, 200 mL) and HCl (0.84 mL, 37 wt %, total concentration 0.05 M) were added. After stirring the reaction mixture with a mechanical stirrer (1400 rpm) at 105 °C for 24 h, the reaction temperature was cooled to room temperature and the reaction mixture transferred to a centrifuge vial (250 mL). Centrifugation (12,000 rpm, 14 min) was followed by separation of the supernatant, which was reused for additional reaction runs (recycling), and the solid material was collected. The collected solids were re-dispersed in distilled water and washed by centrifugation (3×200 mL H₂O). Next, the washed solid cellulose was dispensed into distilled water (200 mL) and homogenized (IKA® T25 ULTRA TURAX, 14,000 rpm) for 90 min. A sample was taken from the suspension for TEM analysis. To determine the yield of the CNF, the suspension was centrifuged (12,000 rpm, 14 min), water was decanted and the solids were dried under rotavapor at 65 °C. Next, the solid CNF was broken down into a powder using mortar and pestle and dried under vacuum for 18 h. The CNF yield was 73 wt %. The recycled LA media was reduced for next reactions by adding sulphite pulp and mixing with mechanical stirrer (1400 rpm) at 105 °C for 24 hours. The separation parts were as before.

### Synthesis of LA Functionalized CNFs in the Presence of HCl, 0.1 M

To a round-bottom flask (500 mL), sulphite pulp (5 g), lactic acid (90 wt %, 200 mL) and HCl (1.7 mL, 37 wt %, total concentration 0.1 M) were added. After stirring the reaction mixture with a mechanical stirrer (1400 rpm) at 105 °C for 24 h, the reaction temperature was cooled to room temperature and the reaction mixture transferred to a centrifuge vial (250 mL). Centrifugation (12,000 rpm, 14 min) was followed by separation of the supernatant, which was reused for additional reaction runs (recycling), and the solid material was collected. The collected solids were re-dispersed in distilled water and washed by centrifugation (3×200 mL H₂O). Next, the washed solid cellulose was dispensed into distilled water (200 mL) and homogenized (IKA® T25 ULTRA TURAX, 14,000 rpm) for 90 min. A sample was taken from the suspension for TEM analysis. To determine the yield of the CNF, the suspension was centrifugated (12,000 rpm, 14 min) and the water was decanted and the solids were dried under rotavapor at 65 °C. The solid CNF was broken down into a powder using mortar and pestle and dried for 18 h under vacuum. The CNF yield was 65 wt %.

### Determination of Degree of Substitution (D.S.)

The titration method was used in order to determine the D.S. of samples. 200 mg of sample was dispersed in 16 mL of EtOH (aq) 70 v %, then 8 mL of NaOH (0.5 mol L⁻¹) was added and the mixture was stirred at 60 °C for 24 h. After cooling down to room temperature, 4-3 drops of phenolphthalein indicator were added, and the solution was titrated against 0.5 mol L⁻¹ HCl solution. The DS values were calculated using the following equation.

D.S.=162 M(V₀−V)/1000 W

where: 162 is the molecular mass of an AGU (anhydro glucose unit), V₀ is the volume of HCl solution (mL) consumed for titration of the blank sample (reference), V is the volume of HCl solution (mL) used for titration of the sample, M is the molarity of HCl solution, and W is the weight of sample (g).

### Thermogravimetric Analysis (TGA)

Thermogravimetric analysis (TGA) was carried out under nitrogen gas with flow rate of 75 mL min⁻¹, with a scan rate of 5 °C min⁻¹, using a Mettler Toledo TGA/DSC 1.

The present invention is not limited to the embodiments disclosed but may be varied and modified within the scope of the following claims. For example, although sulphite pulp was used in the examples, the skilled person would understand that any other wood-derived pulp can be used.

1. A process for the preparation of micro- and/or nanocellulose that is surface functionalized with lactic acid ester, comprising the step of
a) mixing wood-derived pulp, which is pulp made of hardwood or softwood, with 80 to 99 wt % lactic acid at a temperature from 90 to 120 °C for 5 to 36 hours under stirring,
wherein wt % are weight percentages of the total weight of the solution or of the final material, and
wherein use of a metal catalyst is disclaimed.

2. The process according to claim 1, wherein the wood-derived pulp is one or more short-rotation energy crops selected from softwoods and hardwoods.

3. The process according to claim 1, wherein the wood-derived pulp is one or more softwoods selected from the group comprising pine, spruce, birch and cedar.

4. The process according to claim 1, wherein the wood-derived pulp is sulphite dissolved wood-derived pulp.

5. The process according to claim 1, wherein micro- and/or nanocellulose has a maximum diameter of 1 μm or less and includes cellulose microfiber or microfibrilated cellulose (MFG) and CNF.

6. The process according to claim 1, using 85 to 95 wt % lactic acid.

7. The process according to claim 1, wherein the temperature is from 100 to 110 °C.

8. The process according to claim 1, wherein the process is performed for 20 to 30 hours.

9. The process according to claim 1, wherein lactic acid is D,L-Lactic acid or L-Lactic acid.

10. The process according to claim 1, wherein the process comprises an additional step b) removing the obtained ester by alkaline hydrolysis.

11. The process according to claim 1, comprising the steps of
b) cooling the mixture,
c) separating solid and supernatant, which supernatant can optionally be recycled,
d) washing the solid,
e) drying the solid.

12. The process according to claim 1, wherein lactic acid is recycled.

13. The process according to claim 1, wherein the obtained micro- and/or nanocellulose has a Degree of Substitution between 0.15 and 0.25, or 0.20 and 0.22.

14. The process of claim 11 comprising the step of:
f) removing the obtained ester by alkaline hydrolysis.
